(19) United States
(12) Patent Application Publication
(10) Pub. No.: US 2023/0003270 A1
(43) Pub. Date: Jan. 5, 2023

(54) OPERATING UNIT FOR AN ELECTRIC PARKING BRAKE

(71) Applicant: SFS Group International AG, Heerbrugg, St. Gallen (CH)

(72) Inventors: Edi PERIC, Heiden (CH); Stefan FREI, Chur (CH); Christian SUTTER, Appenzell (CH)

(73) Assignee: SFS Group International AG, Heerbrugg, St. Gallen (CH)

(21) Appl. No.: 17/777,327

(22) PCT Filed: Nov. 17, 2020
(86) PCT No.: PCT/EP2020/082336

§ 371 Date: May 17, 2022

(30) Foreign Application Priority Data
Nov. 18, 2019 (EP) 19209806.9

(51) Int. Cl. F16D 65/18

(52) U.S. Cl. CPC F16D 65/18; F16D 2121/24

(57) ABSTRACT

An operating unit for a parking brake of motor vehicles including an operatively connected unit having of a drive spindle and nut, which forms an axially longitudinally adjustable element of a linear drive. The drive spindle has a drive side for connection to an electric drive and a substantially cylindrical spindle portion having an external thread. The nut has a sleeve-shaped central body having an internal thread and a head portion designed to act as a pressure piston on a brake element of the parking brake. The internal and external threads intermesh in the operative connection and define a common axial axis of rotation. The thread is a symmetrical thread, and the flank angles, relative to a radial reference plane perpendicular to the axis of rotation, have angle values which are substantially equal in magnitude.

### TECHNICAL FIELD

The present invention relates to an operating unit of nut-spindle design for a parking brake of motor vehicles.

### BACKGROUND

A parking brake for motor vehicles according to the prior art is frequently operated via cable pulls which can be held in an end position by latching devices via hand- or foot-operated levers. The brake element of the hydraulically or pneumatically operated service brake is normally locked mechanically in this end position.

In recent years, these purely mechanical parking brakes have been increasingly replaced with electric brake systems. These use a threaded spindle/nut combination as an axially adjustable element of a linear drive. A threaded spindle is driven by an electric motor and acts on the thread of the encompassing nut. A longitudinal movement of the nut along the spindle axis is brought about by the spindle rotation. If the nut is connected to a piston element which acts on a brake pad, a (parking) braking action can be achieved. A nut-spindle system furthermore has the advantage that it is secure in a currentless state because the self-locking of the thread, combined with a normally present reduction gearbox and the drive motor, holds the brake in the locked position.

The nut-spindle system acts from a technical perspective as a worm gear, wherein the reduction or step-up is determined by the dimensioning of the threaded spindle and the pitch of the thread. Very short reaction times are normally not required for parking brake systems; in contrast, it must be possible to generate sufficiently high clamping forces on the brake so that a vehicle can be held securely in the loaded state even when parked on a slope. For this reason, nut-spindle systems are primarily used and less frequently the more complex and costly, but smoother running ball screw drives.

### OBJECT AND SUMMARY

The intention below is to consider the thread design which is typically used when constructing a nut-spindle system. The actuating forces when operating a parking brake act on the nut-spindle system substantially along the central longitudinal axis of the system. The transmission of force between threaded spindle and nut is performed here via the threads which engage in one another; depending on the loading direction via the flanks, which slide in each case on one another, of the threads of nut and threaded spindle. Since the structural length of the mounted operating unit consisting of drive spindle and nut varies depending on the position of the thread, the overall surface area of the force-transmitting flanks also changes. Moreover, depending on the pull-out length of the nut-spindle combination, the angle play, therefore the possible lateral deflection or tilting of the threaded spindle relative to the nut, can be of varying magnitude.

For the purpose of understanding, reference is made to FIG. 4, where an asymmetrical thread is shown, in the case of which the thread has flanks with varying gradient. A situation is shown, where force Fₐ acting on the nut (force parallel to the axis of the nut-spindle unit) presses the steeper threaded flanks of nut and threaded spindle onto one another.

FIGS. 2 and 3 now considers this situation on an isolated thread flank: Fₐ acts axially, which enables a separation of the forces as shown in the force parallelogram. A force component Fₛ is produced which is introduced into the thread perpendicular to the flank and a radial component Fᵣ. Aₐₛ and A_{sy} designate the flank surfaces which are effectively in frictional engagement with the mating flank. It becomes clear from a comparison of FIGS. 2 and 3 that force Fₐ acting axially on Aₐₛ or A_{sy} can be deflected better into the material in the case of a thread with steep flanks than with flatter flanks. This has two clear advantages: On one hand, the compressive load on the surface is lower because perpendicular force component Fₛ is smaller in the case of flatter flanks (with identical Fₐ). Secondly, radial force component Fᵣ is also smaller. There is, however, a component—Fᵣ in mirror symmetry to the central axis of the system which (largely) cancels out this component. As a result of manufacturing tolerances, considered via the thread length in engagement, a resultant force can, however, be produced which leads to a tilting moment on the nut-spindle system and thus increases wear.

Since, in the case of parking brake systems, the maximum load occurs for the operating unit when the system is moved into the braking position, it is therefore obvious to select an asymmetrical thread because the load peaks can thus be better deflected from the nut onto the spindle.

Nut-spindle systems for the described use as part of a linear drive are, on the grounds of cost, often manufactured as cold formed workpieces from steel. The threads are in this case rolled, i.e. cold formed with special machines. The thread is grooved by suitable chamfering rollers into a cylindrical or hollow-cylindrical raw form. This can thus be performed as an internal thread (nut) or as an external thread (spindle). The cold forming ensures higher thread strength and can enable smoother and better surface structures without chip formation.

A side effect in the case of thread rolling is the formation of what are known as closing folds. During thread production, the tool presses the thread profile into the blank and displaces the material from the thread base into the thread tips. This thus occurs for each thread simultaneously from both flanks. The boundary between these two displacement fronts can lead at the thread tip to a more or less pronounced closing fold along the thread tip depending on the degree of forming, material and process control; where the material displacement is at its highest, the thread is, however, at its narrowest. Closing folds are disadvantageous for the load capacity of the region of the thread tip.

An asymmetrically arranged closing fold also arises in the case of an asymmetrical thread. Studies have thus shown that this closing fold does not weaken both thread flanks to the same degree; interestingly, the steeper thread flank is affected to a greater extent. This can have a negative impact due to the force distribution shown above. As the comparison of FIGS. 2 and 3 shows, force component Fₛ (vectorial) introduced into the material in the case of flatter flanks is necessarily inclined to a greater extent with respect to the central axis than in the case of the steeper flank. Pictorially, the force vector tends to aim past the closing fold in the case of the flatter thread flank, into the volume of the threaded tooth which is advantageous for the introduction of force and unaffected by the closing fold.

The material in the case of asymmetrical threads in the thread base, relative to the original surface, is notched to a greater extent at the foot of a steeper flank than in the case of a flatter flank, likewise as a result of the thread shaping. The material in the thread base is thus subject to locally greater loads, which can facilitate the formation of micro-cracks.

All of these considerations mean that the approach from the prior art, configuring the nut-spindle systems of the operating unit for parking brake systems with an asymmetrical thread, does not appear to be fundamentally advantageous. Operating units according to the present invention are characterized by simplified production and improved efficiency while the locking forces in the end position correspond to the same requirements.

An operating unit for a parking brake of motor vehicles comprises an operatively connected unit consisting of drive spindle and nut which forms an axially length-adjustable element of a linear drive and acts as such. The drive spindle has a drive side for connection to an electric drive and a substantially cylindrical spindle portion with an external thread. The nut has in contrast a sleeve-shaped central body with an internal thread and furthermore a head portion which is formed in order to act as a pressure piston on a brake element of the parking brake. Central body and head portion of the nut can, just like drive side and spindle portion of the drive spindle, be embodied in one piece or be composed in a frictional, positive-locking or firmly bonded manner of two components. Internal and external threads of the operating unit intermesh as threads in the operative connection and define a common axial axis of rotation (A).

According to the invention, the thread is designed as a symmetrical thread, in the case of which the flank angles (α, α′), relative to a radial reference plane (R) perpendicular to the axis of rotation (A), have angle values which are substantially equal in magnitude.

In one preferred embodiment of the operating unit, the drive spindle is essentially embodied as a cold formed metal molded part. In a further embodiment, the nut is essentially embodied as a cold formed metal molded part.

In both cases, essentially means that, apart from pre-treatment or post-treatment steps (such as production of the raw form before thread rolling, heat treatment, surface tempering, hardening, cleaning, turning over or finishing), the key forming steps are performed by cold forming and not by machining.

In a further embodiment of an operating unit, the flank angles (a, a′) are selected between 12°-18° (in each case inclusive), preferably between 13° and 15°.

The use of an operating unit as an axially length-adjustable element of a linear drive for a parking brake of motor vehicles is built on an operatively connected unit comprised of drive spindle and nut. The drive spindle has a drive side for connection to an electric drive and a substantially cylindrical spindle portion with an external thread. In contrast, the nut has a sleeve-shaped central body with an internal thread and furthermore a head portion which is formed in order to act as a pressure piston on a brake element of the parking brake. Central body and head portion of the nut can, just like drive side and spindle portion of the drive spindle, be embodied in one piece or be composed in a frictional or positive-locking or firmly bonded manner of two components. Internal and external threads of the operating unit intermesh as threads in the operative connection and define a common axial axis of rotation (A). The thread is designed as a symmetrical thread, in the case of which the flank angles (a, a′), relative to a radial reference plane (R) perpendicular to the axis of rotation (A), have angle values which are substantially equal in magnitude.

### BRIEF DESCRIPTION OF THE DRAWINGS

FIG. 1 shows an operating unit consisting of nut and spindle in longitudinal section.

FIG. 2 and FIG. 3 show a thread portion in section transverse to the thread.

FIG. 2 schematically represents an asymmetrical thread, FIG. 3 a symmetrical thread.

FIG. 4 shows a cut-out from an asymmetrical thread with a thread in engagement.

FIG. 5 shows a schematic diagram of a thread tooth with closing fold in cross-section.

### DETAILED DESCRIPTION

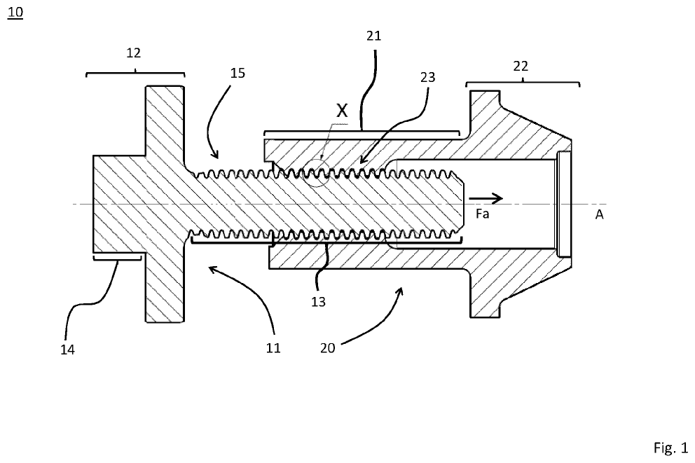

FIG. 1 shows an operating unit 10 as a system consisting of nut 20 and drive spindle 11 in operatively connected engagement. Such an assembly can be used as a linear drive element in an electric parking system, is per se, however, also suitable for technically equivalent tasks such as closing or locking systems in which, in the end position, a constant axial force acts on the assembly.

Drive spindle 11 can be divided substantially into two sub-portions. On one hand, drive side 12 which can enclose a bearing 14. The transmission of force is performed here from a drive motor. This transmission can be performed, as known in the prior art, from a drive motor via a clutch element directly or indirectly via a transmission, toothed belt or another suitable means. The other lower portion is actual spindle thread portion 13. It is technically embodied as a substantially rod-shaped structural element with an external thread 15. This drive spindle 11 is shown in operative connection with a nut 20. The latter can be divided into a head portion 22 and a sleeve-shaped central body 21 which bears an internal thread 23. In the installed state, drive spindle 11 is normally mounted to be stationary, but rotationally driven in a brake system. Nut 20 is mounted axially displaceable relative to drive spindle 11. Head portion 22 can be formed as a part of a pressure piston which acts on a brake element such as e.g. a brake shoe. Nut 20 and drive spindle 11 possess in the operatively connected state a common central axis A which forms a central longitudinal axis for the thread.

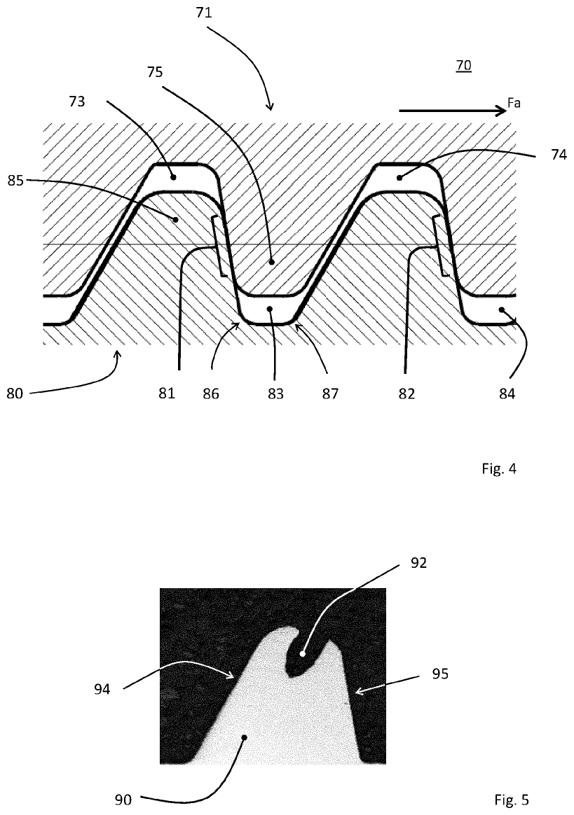

Marked portion X corresponds (by way of example) to FIG. 4. The thread shown is purely schematic.

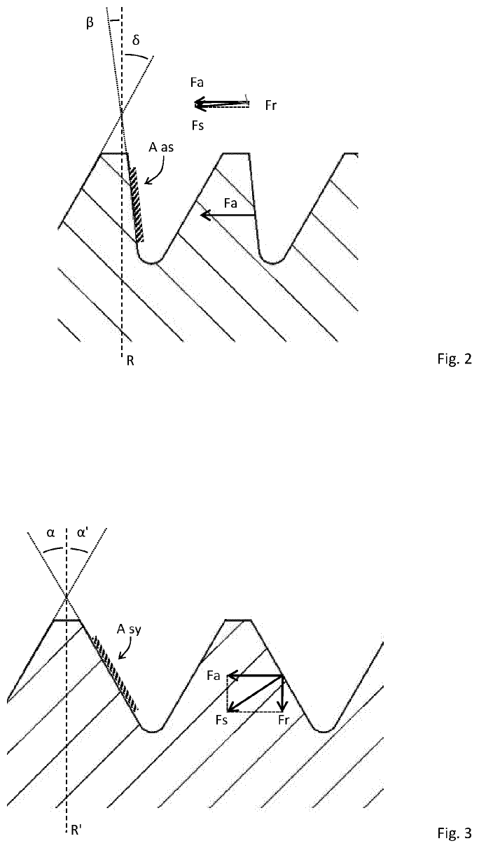

FIGS. 2 and 3 show a partial section through a spindle or nut along the central axis with several threads. FIG. 2 shows an asymmetrical thread with thread flanks of varying gradients, FIG. 3 shows a symmetrical thread. In FIG. 2, a radial plane R runs through the point of intersection of the elongation of the thread flanks on one hand and stands on the other hand perpendicular on central longitudinal axis A (not shown here). Both angles θ and 6 are selected to be of different magnitudes, in the example shown, 0<S.

Aₐₛ schematically indicates that surface which serves during operation as a contact surface for the mating flank. It is apparent that plotted force Fₐ hits the contact surface at an angle 90°—α. The steeper the flank, the smaller β is and accordingly the smaller force component Fᵣ which acts in the radial direction is. How steep the second flank can be selected in the case of given angle β depends among other things on the pitch of the thread.

FIG. 3, in an analogous manner to FIG. 2, shows the ratios in an idealized symmetrical thread with substantially identical flank angles α, α′. It is apparent on the basis of the force parallelogram why a symmetrical thread structure was not favored earlier for the use described—the surface pressure calculated with Fₛ is higher in the case of identical Fₐ in FIG. 3 than in FIG. 2. A_{sy} schematically designates the contact surface with the mating flank in interactive connection.

FIG. 4 corresponds approximately to cut-out X in FIG. 1, but a detail 70 with an asymmetrical thread is shown. Thread portion 71 should be assigned by way of example to the nut, (lower) thread portion 80 to the drive spindle. Spaces 73, 74, 83, 84 shown in FIG. 4 arise because thread base and thread tip of a transmission enable restricted play of nut and spindle and also act during operation as a lubricant depot. A thread tooth 75 of the nut contacts a thread tooth 85 of the drive spindle in a restricted area which is marked as flank surface 81 or 82 and corresponds to Aₐₛ in FIG. 2. It is apparent in the region of space 83, in the thread base, that the notching effect at transition 86 of the steeper flank into the thread base is greater than in the case of transition 87. Arrow Fₐ indicates the axial force action which presses the thread flanks onto one another as shown.

FIG. 5 shows, in a schematic section, a thread tip 90 with two flanks 94 and 95 of different gradients of an asymmetrical thread with a closing fold 92.

The features of the invention disclosed in the above description, in the drawings and in the claims can be significant both individually and also in any desired combination to achieve the invention.

1. An operating unit for a parking brake of motor vehicles, the operating unit comprising: an operatively connected unit including a drive spindle and a nut which acts as an axially length-adjustable element of a linear drive;
the drive spindle has a drive side for connection to an electric drive and a substantially cylindrical spindle portion with an external thread;
the nut has a sleeve-shaped central body with an internal thread and a head portion formed in order to act as a pressure piston on a brake element of the parking brake;
the internal and external threads intermesh as an operative connection and have a common axial axis of rotation;
the threads are symmetrical threads and flank angles of the threads relative to a radial reference plane perpendicular to the axis of rotation, have angle values which are substantially equal in magnitude.

2. The operating unit as claimed in claim 1, wherein the drive spindle is formed as a cold formed metal molded part.

3. The operating unit as claimed in claim 1, wherein the nut is formed as a cold formed metal molded part.

4. The operating unit as claimed in claim 1, wherein the flank angles are selected to be from 12° to 18°.

5. A linear drive for a parking brake of motor vehicles comprising the operating unit as claimed in claim 1.
